(19) United States
(12) Patent Application Publication
(10) Pub. No.: US 2011/0202440 A1
(43) Pub. Date: Aug. 18, 2011

(54) Identification Module and Pointing Method Using Such a Module

(76) Inventor: Samer Jarrah, Creteil (FR)

(21) Appl. No.: 13/057,460

(22) PCT Filed: Jul. 29, 2009
(86) PCT No.: PCT/FR2009/051528

§ 371 Date: Apr. 28, 2011

(30) Foreign Application Priority Data
Aug. 4, 2008 (FR) 08/04449

(51) Int. Cl. G06F 17/00; G06Q 40/00; G06Q 10/00

(52) U.S. Cl. 705/32; 705/44; 235/375

(57) ABSTRACT

Portable identification module including a housing of pocket format and containing a sensor of a biometric characteristic at the surface of said housing; an element for processing the biometric characteristic providing a numerical result; and a transmitter suitable for sending said numerical result in a secure form via a DTMF signal through a telephone pathway.

The invention relates to an identification module and a method for clocking in and out from a remote worksite using this module.

There are many identification devices currently in existence which use a biometric technique such as the analysis of a fingerprint, handprint, iris of the eye, etc.

However, such devices are often very costly and require the installation of an appropriate infrastructure, for example wiring the place of use. Then these devices are perfectly suited for recording the hours worked by employees.

Methods and devices enabling employees to record the length of their workday for their employer have been in use for years. Time clocks are generally placed at the entrance to the business and are directly or indirectly connected to a processing unit which calculates the hours worked by each employee and the corresponding salary. This type of timekeeping does not raise any issues regarding the legalities of its use when the employees are working on site at their own company. As long as the time clocks comply with regulations concerning personal data, they can include a means of biometric analysis in order to increase security and/or facilitate use, for example by eliminating the need for badges.

However, this implementation is much more difficult when the employee is assigned to perform work at another company, such as maintenance or access to sensitive sites. In such operations, the service providers must send someone to the worksite to clock the employees in and out. Because of the difficulties of implementing such a solution, often no timekeeping system is used.

An objective of the invention is to provide a solution for clocking employees in and out when they are working at locations that are not on the premises of their employer.

For this purpose, one aspect of the invention relates to a portable identification module comprising:
a housing that will fit in a pocket and that contains:
a sensor, on the surface of said housing, for capturing a biometric characteristic,
a processing element for processing the biometric characteristic and providing a numeric result, and
a transmitter suitable for sending said numeric result in a secure form via a DTMF signal over a telephone channel.

In certain embodiments, usable alone or in combination:
the DTMF signal is a signal modified to be carried over the telephone channel as a voice signal,
the module comprises a cover mounted on the housing to be movable between a position protecting the sensor and a position uncovering the sensor to enable its use,
the processing element comprises memory containing information about at least one reference biometric characteristic and a comparator for comparing the captured biometric characteristic to each reference biometric characteristic, with the numeric result being the result from said comparator and suitable for indicating whether or not the captured biometric characteristic corresponds to the, or to one of the, reference biometric characteristic(s),
the memory then also contains an identifier associated with each reference biometric characteristic, and the numeric result transmitted is the identifier corresponding to the recognized biometric characteristic,
the processing element is adapted so that the numeric result is the biometric template, or a signature of it, for the captured biometric characteristic,
the module additionally comprises a receiver for receiving an acoustic signal, suitable for establishing, together with the transmitter, a communication session with an IPBX server via any telephony device,
the module additionally comprises a payment means for triggering a payment authorization sent by the transmitter, the module's processing means comprising memory containing a validation biometric characteristic and only activating the payment means if the captured biometric characteristic corresponds to the validation biometric characteristic,
the module additionally comprises an accommodation for an RFID tag and allows the default deactivation of said RFID tag, with the module's processing means comprising memory containing a validation biometric characteristic and only activating the RFID tag if the captured biometric characteristic corresponds to the validation biometric characteristic.

In a second aspect of the invention, a method for clocking times comprises a configuration phase and an operating phase, with the configuration phase comprising the steps of:
assigning to at least one user
the above identification module containing a biometric characteristic of said user and an identifier, and
at least one authorized telephone number for the user;
storing on an IPBX server the identifier and the authorized telephone number for the user;
   and the operating phase comprising the steps of:
at the time of arrival at and departure from the worksite, the user calls the server from the telephone, and
the identification module authenticates the user by verifying a captured biometric characteristic of the user, and
if the authentication is successful, the module sends a successful authentication signal containing the user identifier to the server, and
at the server, the calling number and the identifier are verified and the time of the call and the identifier are stored in a clocked time archive file.

The invention can be used from a fixed or mobile telephone. It enables the logging of employee hours. The presence of the user at the worksite is confirmed by using a fixed telephone at the worksite or by determining the location of a call from a mobile telephone. The IPBX server can handle the recognition of the telephone number and the storing of call data such as the calling number and time, using a simple method. Clocking in and out is thus simple and reliable.

The user is identified by the identification module, which ensures that the person calling is actually the person on record, by means of the biometric characteristic.

If the calling number is different from the telephone number of the workplace of the user whose identifier has been communicated to the server, the identifier and the calling time are archived in a failure file.

It is possible to keep track of failed attempts to clock in and out, for possible processing by an operator at a later time.

Other features and advantages of the invention will become apparent from reading the following description of a particular non-limiting embodiment of the invention.

It refers to the attached drawings, in which:

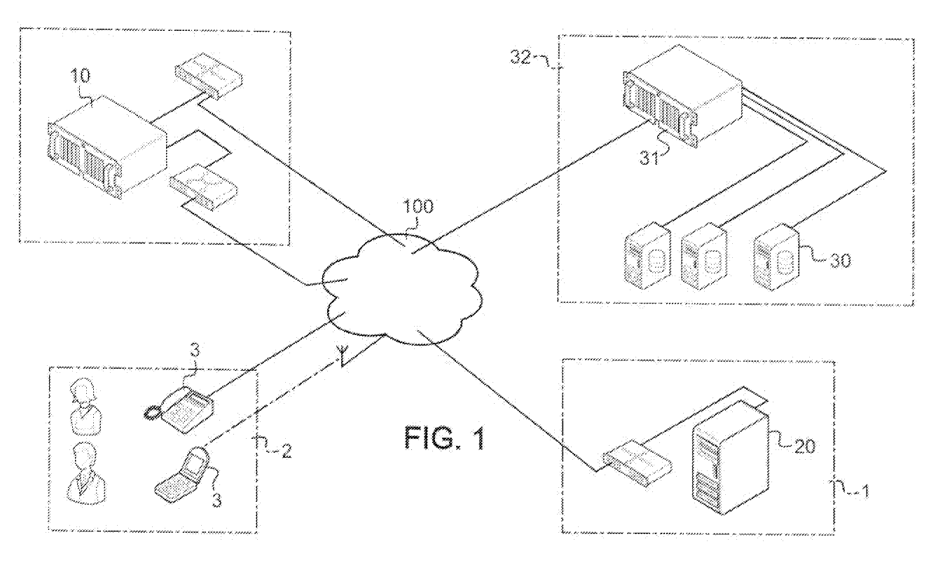

FIG. 1 is a schematic view of a time clocking system according to an embodiment of the invention, illustrating the use of a method for clocking in and out according to an embodiment of the invention,

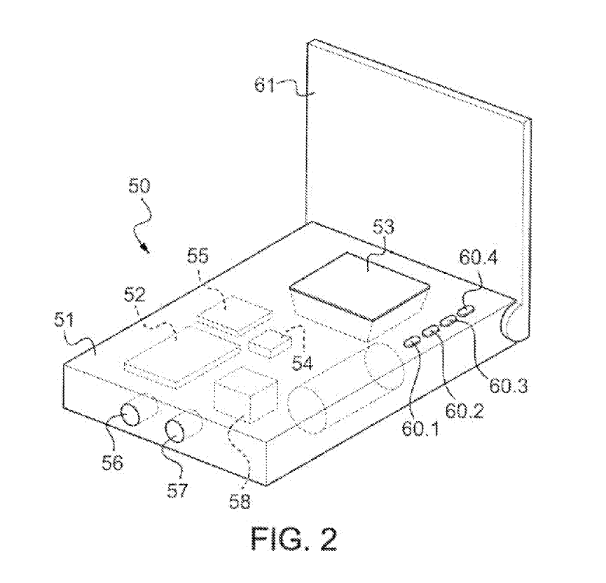

FIG. 2 is a schematic perspective view of an identification module according to an embodiment of the invention, and

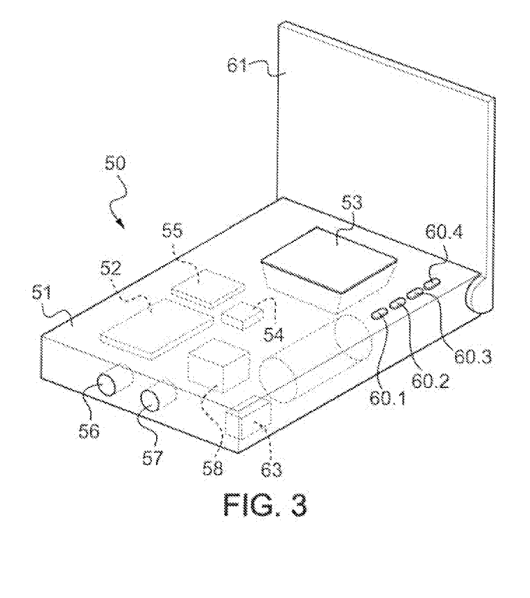

FIG. 3 is a schematic perspective view of a variant embodiment of the module in FIG. 2.

As shown in FIG. 1, the method and system for clocking in and out are arranged to allow users working off the premises 1 of the company employing them, at locations 2 equipped with telephones 3, to communicate the hours they are present at their worksites. The telephones 3 are connected to a telecommunication network 100, here comprising the telephone network and the Internet network.

The method for clocking in and out is implemented by a system comprising an IPBX server 10 on a platform for receiving calls through a telephone company. The IPBX server 10 is associated with memory which contains:
user identifiers and telephone numbers for at least one of the telephones 3 at the worksite for each user, with the users being authorized to call the IPBX server 10 from said telephones in order to clock in or out,
a clocked time archive file,
a clocking attempt failure archive file.

The IPBX server 10 is connected to the network 100 by a Voice over Internet Protocol (VoIP) processing means, with said means handling the decompression of streams from the Internet. The IPBX server 10 can be reached by a telephone number such as a toll-free number.

The method of the invention comprises a phase of configuring the IPBX server 10, consisting of the following steps:
assigning to at least one user an identifier and at least one telephone number for a telephone 3 at the user's worksite 2,
storing in the IPBX server 10 the identifier and the telephone number(s) of the telephone(s) 3 at the user's worksite 2.

The user identifier comprises a sub-identifier for the company employing the user and a personal sub-identifier for the user. Preferably, the company stores in a table contained on a server 20 the identifiers of its employees working away from its premises 1 and one or more numbers for telephones 3 located at the employees' worksite 2. The server 20 is connected to the network 100.

This table is sent over the Internet 100 to a central server 30 for centrally storing time clocking data. Said server communicates these tables to the IPBX server 10 via a web server 31 connected to the Internet 100 and to the server 30. Here, these servers 30 and 31 are hosted at a service provider 32 which maintains a database for each of its customers (only one company 1 is a customer in this example), with each database containing the customer's table and the hours clocked by its remote employees for a given period and accessible by the server 20 to allow the company to update the table and retrieve the clocked hours. In one variant, these servers could be hosted directly by the company employing the users.

The method comprises an operating phase comprising the steps of:
at the time of arrival at and departure from the worksite 2, the user calls the IPBX server 10 from the telephone 3 that he or she is authorized to use and communicates his/her identifier to the IPBX server 10,
the IPBX server 10 verifies the calling number and the identifier and stores the identifier and a time for the call in the clocked time archive file.

During the telephone call to the IPBX server 10, the IPBX server 10 guides the user by sound or voice indications to send his/her identifier at the proper moment via the telephone 3 which he/she is authorized to use. The identifier is sent by modified DTMF signals to the IPBX server 10. Note that the DTMF signals are modified to guarantee that they will be routed by the telephone network as a voice signal and not as DTMF signaling. This modification may, for example, consist of modifying the base frequency of these signals.

The IPBX server 10 checks whether the telephone number used by the user corresponds to one of the stored telephone numbers linked to the identifier provided. If the calling number corresponds to one of these numbers, the IPBX server 10 stores the identifier and a time for the call in the clocked time archive file. If the calling number does not correspond to one of these numbers, or if the calling number is blocked, the identifier and the calling time are stored in a failure archive file.

The service provider periodically sends a query to the web server 31 to retrieve the archive files via the network 100, and stores the clocked times in the database for the client company or companies corresponding to the identifiers stored in the archive file.

To ensure that the person who is clocking in or out is one of the registered users, the user identification includes a user authentication step which verifies biometric data of the user.

The biometric data is captured by an identification module or housing in the possession of the user, and after authentication the module outputs a signal indicating authentication success or a signal indicating authentication failure, transmissible over the telephone channel and recognizable by the server. The IPBX server is programmed to record in the archive file an indication of the authentication success or failure based on an authentication outcome signal sent over the telephone channel during the call. The success signal is, for example, the user identifier.

The portable identification module comprises a sensor for capturing a biometric characteristic, an element for processing a biometric characteristic and providing a numeric result, and a transmitter for sending the numeric result in the form of a DTMF signal over a telephone channel.

In the embodiment detailed here, the biometric characteristic is a fingerprint. Other biometric characteristics can be used, however, such as an analysis of the iris of the eye or the shape of the face, as long as the module remains portable.

The identification module, generally denoted as 50, comprises a housing 51 integrating a microprocessor 52 which constitutes the processing element and is connected to:
a fingerprint sensor 53, here comprising a sensitive surface that is flush with an external surface of the housing 51,
a clock 54,
non-volatile memory 55 containing an authentication program, an encryption program, an encryption key, a history of transactions, and, in encrypted form, a serial number and one or more images of the user's fingerprint,
a microphone 56 and a speaker 67 via a device 58 for transmitting/receiving modified DTMF signals,
a power source 59, in this housing a battery,
light indicators 60.

The housing is sized to fit in a pocket, for example a size smaller than 30 cm3, to allow the user to carry the module easily and without inconvenience so that it is always available to the user. For example, the housing is designed so that the module can serve as a key ring. In the embodiment described, the module assembly weighs less than 50 g.

The authentication program is suitable for capturing an image of the print of a finger placed on the fingerprint sensor 53, and comparing this image to a stored image.

The encryption program encrypts or decrypts data contained in the memory 55 or messages from the IPBX server 10.

Preferably, the identification module is turned on by means of a switch associated with a cover 61 mounted on the housing and movable between a position protecting the fingerprint sensor 53 and a position uncovering this sensor to enable its use.

In this example, the light indicators 60 comprise:
a confirmation indicator 60.1,
an error indicator 60.2,
an indicator 60.3 indicating that the module is to be placed next to the speaker of the telephone,
an indicator 60.4 indicating that the module is to be placed next to the microphone of the telephone.

The clock 54 here is a real-time clock having a precision of about two minutes per year.

An operating mode of this module will be described as an example.

A user wanting to clock in calls the IPBX server 10 from an authorized telephone and opens the cover 61. The microprocessor 52 briefly lights up the indicator 60.1 if the level of the battery charge is sufficient, to show that the module is ready to operate. If the level of the battery charge is too low, the microprocessor 52 blinks the indicator 60.2 to show that the battery needs changing.

In the first housing, the microprocessor 52 waits for the presence of a finger on the fingerprint sensor 53.

When a finger is detected, an image of the fingerprint is captured and compared to the stored image by the microprocessor 52 after encryption.

If the comparison is successful, the indicator 60.4 is lit and an encrypted DTMF message is sent. This message contains: the serial number of the module 50, the battery status, the local time provided by the clock, the validity of the time (battery changed or not), and a value for verifying the message integrity such as a checksum. This message serves to indicate a successful authentication. The user is then identified by the relation between the serial number of the module and the user, established when the module was assigned to the user. The message can also contain a digital signature for the fingerprint, or an identifier associated with this fingerprint, as these allow the server to determine the identity of the user.

If the message is properly received by the IPBX server 10, an audio message is sent to the telephone the user is using. The local time and the identifier are stored in the clocked time archive file.

If the comparison fails, the microprocessor 52 lights up the indicator 60.2.

Note that if the clock was reinitialized, it is not possible to clock in or out and a configuration phase must be performed.

In the configuration phase, a fingerprint is recorded in the identification module and sent directly to the IPBX server 10, and the time of the clock 54 is set.

A user wanting to enter the configuration phase calls the IPBX server 10 from an authorized telephone and opens the cover 61. The microprocessor 52 briefly lights up the indicator 60.1 if the level of the battery charge is acceptable, to show that the module is ready to operate. If the level of the battery charge is too low, the microprocessor 52 blinks the indicator 60.2 to show that the battery must be changed.

In the first housing, the microprocessor 52 waits for the presence of a finger on the fingerprint sensor 53.

When a finger is detected, an image of the fingerprint is captured and compared to the stored image by the microprocessor 52 after encryption.

If there is no stored print, the microprocessor 52 blinks the indicator 60.3 and sends an encrypted DTMF message containing: the serial number of the module 50, the battery status, the local time provided by the clock, the validity of the time (battery changed or not changed), the presence of a stored fingerprint, and a random check byte.

The microprocessor then blinks the indicator 60.3 to tell the user to place the module 50 next to the telephone speaker.

The IPBX server 10 then sends an encrypted message containing: the authorization to record a fingerprint, a time for the clock 54 if the time is not valid, a copy of the random byte, and a value for verifying message integrity such as a checksum.

An operation of recording the fingerprint is then performed. The beginning of this operation is, for example, indicated by a sound or light signal.

If it is impossible to connect to the IPBX server, it is possible to have the clocked times stored in the identification module 50 for later transmission.

Variants of the identification module may exist for specific uses.

It can record multiple biometric characteristics for the same person or biometric characteristics for several people. In the latter housing, an identifier is associated with each fingerprint/person. This identifier is sent by the transmitter, and the receiving server is able to determine the person who used the module. This advantageously allows an entire team needing to clock their hours from the same location to use a single identification module.

The possibility of recording several fingerprints for the same person allows the addition of a security condition, defining one of the fingers as an alert, to be used when the user is acting under constraint. This informs the server that the current operation is not being performed at the user's own volition.

The numeric result sent can be the biometric template of the fingerprint, meaning the set of coordinates for the minutiae defining the uniqueness of a fingerprint or an encoding of this template. The user is then identified at the server, which compares the template received against a database of known templates. For other biometric characteristics such as the iris or the shape of the face, the template is the set of coordinates of noteworthy points defining the uniqueness of the characteristic.

In this variant embodiment, the identification module no longer needs to be configured for a particular user.

This also enables remote identification of a user. For example, Alice calls Bob in order to send him confidential information. Bob wants to verify Alice's identity in a reliable and unforgeable manner, so Bob asks Alice to identify herself using the identification module:
Alice places the identification module by the microphone of her telephone,
Alice places her finger on the fingerprint sensor 53,
The identification module sends the code and/or the template in the modified DTMF format,
The IPBX intercepts the data, decrypts it, and sends it to the fingerprint identification server,
If the fingerprint is recognized, the IPBX sends a short beep to Bob's telephone (or any signal defined as a positive recognition),
If the fingerprint is not recognized, it sends a long beep to Bob's telephone (or any signal defined as a negative recognition).

In a third variant, the identification module has charge card information stored in its memory to allow making secure payments remotely. The ability of the biometric module to store multiple fingerprints means it can be used by several people. For example:
A consumer makes purchases on an internet site. At the time of payment the site assigns an order number, e.g. 2475, and asks him to call a telephone number to pay for his order,
The consumer calls a telephone number,
A voice server asks him to enter his order number, then
The voice server asks him use the identification module to identify himself,
The consumer places the identification module by the microphone for his telephone and places his finger on the sensor 53,
The identification module sends the information necessary for payment, as modified DTMF,
The IPBX sends this information to a secure payment site,
The voice server confirms or does not confirm the validity of the payment.

In a fourth variant, as shown in FIG. 3, the identification module houses an RFID tag in a compartment 63 provided specifically for this purpose. The electronic board of the identification module is equipped with a circuit 62 specially designed to prevent the RFID tag from transmitting its code when it is in the presence of an activation radio signal coming from a transmitter. When the user places his finger on the identification module and the fingerprint is known, the module deactivates the operation of the circuit 62 for 5 seconds, which allows the RFID tag to return to its normal operation.

Widespread use of RFID technology and the traceability, without their knowledge, of consumers carrying such technology poses privacy concerns. This variant advantageously allows the consumer to be in charge of the technology because he is the only one who can make the tag active.

In addition, RFID technology is in increasingly widespread use in intercompany access control systems or electronic payment systems (coffee machine, photocopier, cafeteria, etc.). The temporary or permanent theft of such a card raises serious security issues. In this variant, if the card is stolen, it is unusable.

The invention has been illustrated and detailed in the drawings and the above description. This is to be considered an illustrative example, and not as limiting it solely to this description. Many variant embodiments are possible.

The memory of the module may also contain the user identifier, and the control element is suitable for sending the identifier over a telephone channel in the form of modified DTMF signals.

When the method is implemented in multiple countries, it is preferable if only one IPBX server is used. In this housing, a number is provided for each country for reaching the call platform of a telephone company in each country, which resends the communication to the IPBX server via an SDSL connection for example.

The invention can also be used with mobile or cellular telephones. In addition, it is possible to determine the location of the telephone by means of an integrated GPS transmitter/receiver or by the telephone company.

The module can integrate a GPS transmitter.

In the claims, the word “comprises” does not exclude other elements, and the indefinite article “a” or “one” does not exclude the plural.

1. A portable identification module comprising
a housing that will fit into a pocket and that contains:
a sensor on the surface of said housing, for capturing a biometric characteristic,
a processing element for processing the biometric characteristic and providing a numeric result, and
a transmitter suitable for sending said numeric result in a secure form via a DTMF signal over a telephone channel.

2. A module according to claim 1, wherein the DTMF signal is a signal modified to be carried over the telephone channel as a voice signal.

3. A module according to claim 1, comprising a cover mounted on the housing to be movable between a position protecting the sensor and a position uncovering the sensor to enable its use.

4. A module according to claim 1, wherein the processing element comprises memory containing information about at least one reference biometric characteristic and a comparator for comparing the captured biometric characteristic to each reference biometric characteristic, with the numeric result being the result from said comparator and suitable for indicating whether or not the captured biometric characteristic corresponds to the, or to one of the, reference biometric characteristic(s).

5. A module according to claim 4, wherein the memory also contains an identifier associated with each reference biometric characteristic and the numeric result transmitted is the identifier corresponding to the recognized biometric characteristic.

6. A module according to claim 1, wherein the processing element is adapted so that the numeric result is the biometric template, or a signature of it, for the captured biometric characteristic.

7. A module according to claim 1, additionally comprising a receiver for receiving an acoustic signal, suitable for establishing, together with the transmitter, a communication session with an IPBX server via any telephony device.

8. A module according to claim 1, additionally comprising a payment means for triggering a payment authorization sent by the transmitter, and wherein the processing means of the module comprises memory containing a validation biometric characteristic and said processing means is adapted to activate the payment means only if the captured biometric characteristic corresponds to the validation biometric characteristic.

9. A module according to claim 1, additionally comprising an accommodation for an RFID tag and enabling the default deactivation of said RFID tag, and wherein the processing means comprises memory containing a validation biometric characteristic and said processing means is adapted to activate the RFID tag only if the captured biometric characteristic corresponds to the validation biometric characteristic.

10. A method of clocking in and out, comprising a configuration phase and an operating phase, with the configuration phase comprising the steps of:
assigning to at least one user
an identification module according to claim 1, containing a biometric characteristic of said user and an identifier, and
at least one authorized telephone number for the user;
storing on an IPBX server the identifier and the authorized telephone number for the user;
and with the operating phase comprising the steps of:
at the time of arrival at and departure from the worksite, the user calls the server from the telephone, and
the identification module authenticates the user by verifying the captured biometric characteristic of the user, and
if the authentication is successful, the module sends a successful authentication signal containing the user identifier to the server, and
at the server, the calling number and the identifier are verified and the time of the call and the identifier are stored in a clocked time archive file.
